(19) United States
(12) Patent Application Publication
(10) Pub. No.: US 2025/0031667 A1
(43) Pub. Date: Jan. 30, 2025

(54) ELECTRONIC ANIMAL IDENTIFICATION TAG READER SYNCHRONISATION

(71) Applicant: ALLFLEX AUSTRALIA PTY LTD, Queensland (AU)

(72) Inventors: Leigh Andrew BATEMAN, Queensland (AU); Benjamin Thomas John WILKINSON, Redland Bay (AU); Brian Antony CLAYTON, Queensland (AU)

(73) Assignee: ALLFLEX AUSTRALIA PTY LTD, Queensland (AU)

(21) Appl. No.: 18/918,206

(22) Filed: Oct. 17, 2024

Related U.S. Application Data
(63) Continuation of application No. 17/429,597, filed on Aug. 9, 2021, now Pat. No. 12,144,320.

(51) Int. Cl. A01K 11/00; G01S 5/02; G01S 7/28; G01S 19/14; G01S 19/37; G01S 19/40; G01S 19/42

(52) U.S. Cl. CPC A01K 11/004; A01K 11/008; G01S 5/0252; G01S 7/28; G01S 19/14; G01S 19/37; G01S 19/40; G01S 19/42

(57) ABSTRACT

Approaches for synchronising electronic animal identification tag readers for reading clectronic animal identification tags attached to animals. Embodiments include using a pulse from a GNSS receiver, adjusting for an error between a reference cadence signal and a local cadence signal, and using a synchronisation signal.

### CROSS-REFERENCE TO RELATED APPLICATIONS

This application is a continuation of U.S. patent application Ser. No. 17/429,597, filed Aug. 9, 2021, which is a 371 National Stage Entry of International Patent Application No. PCT/AU2019/050094 filed Feb. 8, 2019, the entire contents of which are incorporated by reference herein.

### FIELD

This relates to synchronising electronic animal identification tag readers for reading electronic animal identification tags attached to animals.

### BACKGROUND

Electronic animal identification tags can be used to identify animals. A tag is securely attached to an animal, often to the animal's ear. By reading the tag, the animal can be uniquely identified. Readers are located in certain areas to read the tags of animals.

### SUMMARY

In a first embodiment, there is provided a method, comprising: receiving a pulse from a GNSS receiver; wirelessly receiving a synchronisation signal from a master reader; selectively determining, based on the synchronisation signal, that a cadence is to be synchronised using the pulse; calculating a transmit period and a receive period based on the pulse; during the transmit period, transmitting a signal to an electronic tag attached to an animal; and during the receive period, monitoring for a received signal from the electronic tag attached to the animal; wherein the method is performed by an electronic animal identification tag reader configured to read an electronic animal identification tag attached to an animal; wherein calculating the transmit period and the receive period based on the pulse comprises: synchronising the cadence based on the pulse, where a first part of the cadence corresponds to the transmit period and a second part of the cadence corresponds to the receive period.

In a second example embodiment, there is provided an electronic animal identification tag reader comprising: a GNSS receiver configured to generate a pulse; a synchronisation signal receiver module configured to wirelessly receive a synchronisation signal from a master reader; a processor configured to selectively determine, based on the synchronisation signal, that a cadence is to be synchronised using the pulse; a cadence calculation module configured to calculate a transmit period and a receive period based on the pulse; a signal transmitter module configured to transmit a signal to an electronic tag attached to an animal during the transmit period; and a signal receiver module configured to monitor for a received signal from the electronic tag attached to the animal during the receive period; wherein the cadence calculation module being configured to calculate a transmit period and a receive period based on the pulse comprises the cadence calculation module being configured to: synchronise the cadence based on the pulse, where a first part of the cadence corresponds to the transmit period and a second part of the cadence corresponds to the receive period.

In a third example embodiment, there is provided a method, comprising: receiving a reference cadence signal; generating a local cadence signal at a local cadence signal generator, the local cadence signal corresponding to a transmit period in which a signal is transmitted to an electronic animal identification tag and a receive period in which a signal from the electronic animal identification tag is monitored; determining an error between the reference cadence signal and the local cadence signal; and adjusting the local cadence signal generator based on the error to minimise the difference between the reference cadence signal and the local cadence signal; wherein the method is performed by an electronic animal identification tag reader configured to read an electronic animal identification tag attached to an animal.

In a fourth example embodiment, there is provided an electronic animal identification tag reader comprising: a cadence signal receiver configured to receive a reference cadence signal; a local cadence signal generator configured to generate a local cadence signal, the local cadence signal corresponding to a transmit period in which a signal is transmitted to an electronic animal identification tag and a receive period in which a signal from the electronic animal identification tag is monitored; an error calculation module configured to determine an error between the reference cadence signal and the local cadence signal; and an error adjustment module configured to adjust the local cadence signal generator based on the error to minimise the difference between the reference cadence signal and the local cadence signal.

In a fifth example embodiment, there is provided a method for reading an electronic tag attached to an animal, comprising: generating a synchronisation signal; encoding the synchronisation signal to generate an encoded synchronisation signal; and wirelessly transmitting the encoded synchronisation signal to one or more slave readers; wherein the method is performed by a master reader in communication with the one or more slave readers, each slave reader being an electronic animal identification tag reader configured to read an electronic animal identification tag attached to an animal.

In a sixth example embodiment, there is provided a reader comprising: a synchronisation signal generator configured to generate a synchronisation signal; a synchronisation signal encoder module configured to encode the synchronisation signal to generate an encoded synchronisation signal; and a synchronisation signal transmission module configured to wirelessly transmit the encoded synchronisation signal to one or more slave readers; wherein the reader is a master reader in communication with the one or more slave readers, each slave reader being an electronic animal identification tag reader configured to read an electronic animal identification tag attached to an animal.

In a seventh example embodiment, there is provided a method, comprising: wirelessly receiving an encoded synchronisation signal from a master reader; decoding the encoded synchronisation signal to obtain a decoded synchronisation signal; synchronising a cadence based on the decoded synchronisation signal; and operating according to the cadence; wherein the method is performed by a slave reader, the slave reader in communication with a master reader, the slave reader being an electronic animal identification tag reader configured to read an electronic animal identification tag attached to an animal.

In an eighth example embodiment, there is provided an electronic animal identification tag reader comprising: a synchronisation signal receiver module configured to wirelessly receive an encoded synchronisation signal from a master reader; a synchronisation signal decoding module configured to decode the encoded synchronisation signal to obtain a decoded synchronisation signal; and a cadence synchronisation module configured to synchronise a cadence based on the decoded synchronisation signal; wherein the reader is configured to read an electronic animal identification tag attached to an animal according to the cadence.

### BRIEF DESCRIPTION OF THE DRAWINGS

The invention is described by way of example with reference to the drawings, which show some embodiments of the invention. However, these are provided for illustration only. The invention is not limited to the particular details of the drawings and the corresponding description.

FIG. 1 shows an example reader system in which electronic animal tag readers are synchronised.

FIG. 2 shows an example approach for generating a synchronisation signal.

FIG. 3 shows an example approach for a reader to be synchronised based on a synchronisation signal.

FIG. 4 shows an example approach for synchronising a reader based on GNSS.

FIG. 5 shows an example method for how to improve the accuracy of a cadence signal generator.

FIG. 6 shows an example reader.

### DETAILED DESCRIPTION

In some embodiments, there are provided approaches for synchronising readers with each other. Synchronising may mean that each reader enters a transmit mode around a same time and enters a receive mode around the same time. System

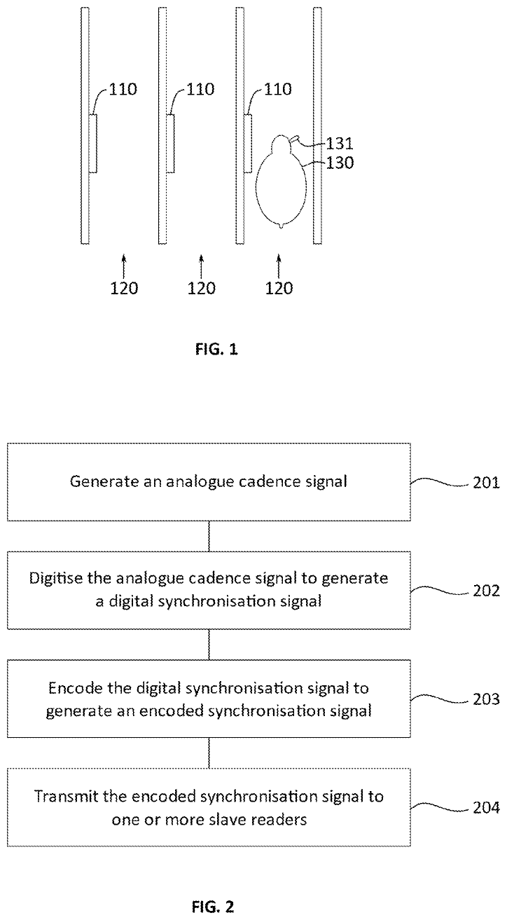

FIG. 1 shows an example reader system in which electronic animal tag readers are synchronised.

The system has a number of electronic animal tag readers 110 distributed around an area, such as a stockyard. Each electronic animal tag reader may be associated with a race 120 through which animals can pass. The races 120 may be at a gateway between the same area to improve the throughput of animals through the areas.

In some cases, readers 110 are widely distributed through an area, and maybe be spaced up to hundreds of metres apart. For example, in a series of pens, one or more readers 110 may be located at each entrance and exit.

In use, animals 130 pass one or more of the readers 110. Electronic animal identification tags 131 attached to each animal (such as to the ear of each animal) are read by one or more of the readers 110. This allows the reader system to identify and monitor the identity and location of animals throughout the area.

The tags 131 are read by a reader 110 transmitting an excitation signal during a transmit mode. When a tag receives the excitation signal, it is energised and so transmits an identifier. The identifier may be a 96-bit code which is unique to the animal. If there are multiple tags 131 attached to the same animal, each tag 131 may use the same identifier. This identifier is received by one or more readers 110 during the readers' receive mode.

The excitation signal is relatively high powered compared to the identifier transmission. In practice, if an excitation signal is being generated by a reader 110, it may be impossible for a reader 110 (either the same reader or a different reader) to receive the identifier. To avoid this, the readers 110 are synchronised so as to enter a transmit mode and a receive mode at roughly the same time.

One of the readers is designated as a master reader 111 and the remaining readers 110 are designated as slave readers. The master reader 111 is configured to set the cadence for each reader 110. That is, the master reader 111 determines when the readers 110 should enter a transmit mode and when the readers 110 should enter a receive mode. This occurs in part by the master reader 111 sending a wireless synchronisation signal to the slave readers. A master reader 111 may be selected to be roughly in the middle of the readers 110 or to have a good wireless communication link to minimise transmission time. The master reader 111 may otherwise operate in the same way as the other readers 110.

In addition, each reader 110 may maintain local cadence generator. This can be used for cadence between synchronisation signals, or if the master reader 111 is unable to send a synchronisation signal.

Due to this synchronisation signal, the readers 110 are in a transmit mode and a receive mode at roughly the same time. For example, there may be a range of about 250 us around which each reader 110 enters the transmit mode or each reader 110 enters the receive mode.

In some cases, one or more of the readers 110 may be a relay, which transmits the synchronisation signal from the master reader 111 to further slave readers 110 which are not in a communication range of the master reader 111.

### Synchronising Using a Synchronisation Signal

FIG. 2 shows an example approach for generating a synchronisation signal.

At step 201, an analogue cadence signal is generated. This typically occurs at a master reader. The purpose of an analogue cadence signal is to determine when an electronic animal tag reader should be in a transmit mode or a receive mode.

The analogue cadence signal may have a predetermined period. For example, the period may be about 60 ms or about 100 ms. This period therefore maps to the time it takes for a reader to complete one transmit mode and one receive mode. A high part of the analogue cadence signal corresponds to the transmit mode and a low part of the analogue cadence signal corresponding to the receive mode. The ratio between these may be selected from a set of predetermined cadences. For example, the ratio of receive to transmit may be one of 80:20, 50:50, or 40:20.

This analogue cadence signal may be used directly at the master reader to control its own transmit mode and receive mode.

The analogue cadence signal may be generated by a cadence signal generator at the master reader. For example, this may be an oscillator, such as a voltage-controlled oscillator.

At step 202, the analogue cadence signal is digitised to generate a digital synchronisation signal.

This may be performed by an analogue-to-digital converter at the master reader, which may be implemented as an integrated circuit. A sampling rate may be set based a desired accuracy and/or the period of the analogue cadence signal. A sampling rate of 1 kHz may be sufficient for a 100 ms cadence signal.

In some embodiments, the digital synchronisation signal may be generated directly, without an analogue cadence signal being generated first. For example, this may be generated by a processor at the master reader based on a hardware cadence signal generator, such as a local oscillator. Where the cadence signal generator is running at a higher frequency than the digital synchronisation signal, the digital synchronisation signal may be generated by dividing down the signal of the local oscillator.

At step 203, the digital synchronisation signal is encoded to generate an encoded synchronisation signal.

The encoding may involve determining a period and/or a cadence based on the digital synchronisation signal and encoding these into bytes representing the signal. The encoded synchronisation signal may therefore be significantly smaller in data size than the digital synchronisation signal.

The encoded synchronisation signal may be a byte sequence (that is, a sequence of 8-bit bytes). A first part of the encoded synchronisation signal may be a predetermined synchronisation sequence to indicate the start of the encoded synchronisation signal and thus to synchronise the time at which the cadence should begin. This may be a predetermined sequence which is correlated to the system of readers. This can allow two master readers operating within a same geographical area to separately set the cadence for its system of slave readers: each slave reader may only act on a synchronisation signal having the particular synchronisation sequence.

A second part of the encoded synchronisation signal may be a cadence sequence. This may be a sequence of byte indicating the cadence ratio and/or the cadence period.

In some cases, the cadence sequence is an index of a cadence dictionary. The cadence dictionary is a map from an index to a particular cadence ratio and/or period. For example, a first index in the cadence dictionary may correspond to a 100 ms period having a receive-to-transmit ratio of 80:20, and a second index in the cadence dictionary may correspond to a 60 ms period having a receive-to-transmit ratio of 40:20. The cadence dictionary may be stored at the master reader and each slave reader in advance.

In other cases, the cadence sequence directly encodes the cadence ratio and/or period. For example, a first sequence of bytes of the cadence sequence may relate to an integer number of milliseconds of the period, a second sequence of bytes of the cadence sequence may relate to the period of the receive mode, and a third sequence of bytes of the cadence sequence may relate to the period of the transmit mode.

The encoding may further comprise including a checksum or redundancy information to ensure that the encoded synchronisation signal, and the information it contains, is correctly received by a recipient.

The encoded synchronisation signal may further include other information related to the master reader. For example, this may include a mode of the master reader or how the original analogue cadence signal was synchronised. If the master reader has a GNSS lock, such that the analogue cadence signal is synchronised via GNSS, this may be indicated in the encoded synchronisation signal.

The encoding may be performed at a signal encoding module at the master reader. The signal encoding module may be a hardware circuit configured to perform the encoding. Alternatively, the signal encoding module may be a series of instructions executable by a processor of the master reader to perform the encoding.

At step 204, the encoding synchronisation signal is transmitted to one or more slave readers.

This may occur through an appropriate technology, such as a suitably configured IEEE 802.11 or other suitable wireless transmission protocol. The range of transmission may be configured to be received by a slave reader within a predetermined range of the master reader, such as 1 km.

This may occur through a synchronisation signal transmission module of the master reader. The transmission module may be a hardware circuit configured to perform the transmission via an antenna. Alternatively, the transmission module may be a series of instructions executable by a processor of the master reader to transmit the data over the antenna.

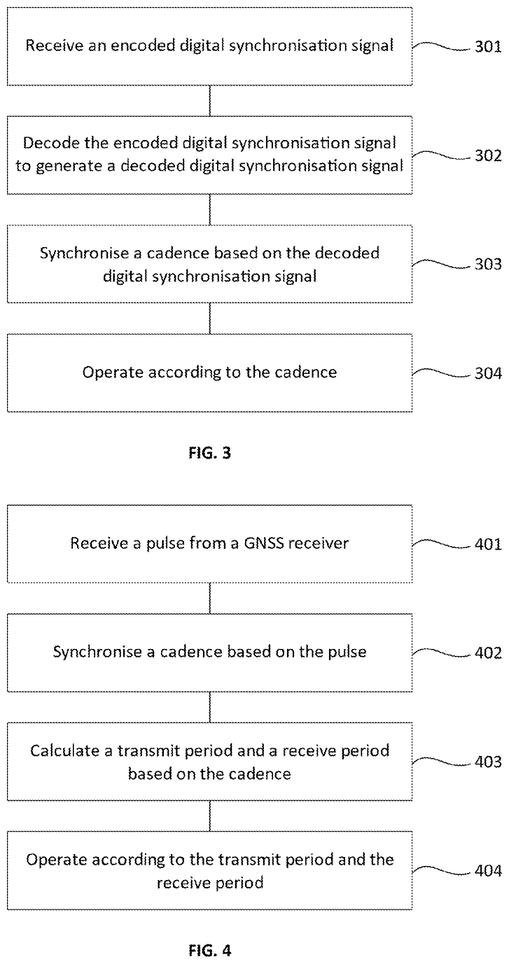

FIG. 3 shows an example approach for a reader to be synchronised based on a synchronisation signal.

At step 301, the encoded digital synchronisation signal is received by a reader.

This may occur at a synchronisation signal receiver module of the reader. The synchronisation signal receiver module may be a hardware circuit configured to perform the receiving via an antenna. Alternatively, the synchronisation signal receiver module may be a series of instructions executable by a processor of the slave reader to receive the data over the antenna.

Receiving the encoded digital synchronisation signal may further include verifying that the encoded digital synchronisation signal was correctly received.

At step 302, the encoded digital synchronisation signal is decoded to generate a decoded digital synchronisation signal.

This may occur by identifying a start time for a cadence. This may be the time at which the decoded digital synchronisation signal is available. Alternatively, the start time may be an estimate of the time at which the analogue cadence signal was generated at step 201, and therefore may be calculated from the time at which the decoded digital synchronisation signal is available to account processing and transmission delays.

In addition, decoding may comprise extracting a cadence ratio and/or period from the encoded digital synchronisation signal, and in particular, from the cadence sequence.

Where a unique synchronisation sequence is used for the master reader, the slave reader may determine that the synchronisation sequence of the encoded digital synchronisation signal matches a predetermined synchronisation sequence. If there is no match, the slave reader may omit further steps.

The decoding may be performed at a signal decoding module at the slave reader. The signal decoding module may be a hardware circuit configured to perform the decoding. Alternatively, the signal decoding module may be a series of instructions executable by a processor of the slave reader to perform the decoding.

At step 303, a cadence is synchronised based on the decoded digital synchronisation signal.

In this context, a cadence comprises a transmit period and a receive period corresponding to when the reader should be in a transmit mode and a receive mode respectively.

Synchronising the cadence may involve determining a transmit period and a receive period based on the cadence ratio and period. For example, a cadence period of 100 ms and a cadence ratio of 80:20 indicates that the reader should have a transmit period of 20 ms and a receive period of 80 ms. These may be measured from the start time for a cadence.

This may further involve updating a cadence signal generator at the slave reader based on the cadence period of the decoded digital synchronisation signal. For example, this may be an oscillator, such as a voltage-controlled oscillator.

This may be performed by a cadence synchronisation module at the slave reader. The cadence synchronisation module may be a hardware circuit configured to perform the synchronising, for example by interacting with the cadence signal generator. Alternatively, the cadence synchronisation module may be a series of instructions executable by a processor of the slave reader to perform the synchronisation.

At step 304, the reader operates according to the cadence.

In this way, the reader may enter a transmit mode according to the transmit period and may enter a receive mode according to the receive period.

Because there are synchronised to the master reader, the reader should have a transmit period and a receive period at approximately the same time as every other reader synchronised to the master reader.

This reduces interference between a reader transmitting while another reader is receiving.

In some cases, the reader may determine not to synchronise a cadence based on the decoded digital synchronisation signal. This determination may be based on other information provided in the encoded digital synchronisation signal. If the information indicated that the master reader does not have a GNSS lock, while the slave reader does have a GNSS lock, the slave reader may determine that the cadence should be synchronised using GNSS.

The methods shown in FIGS. 2 and 3 provide a robust approach for synchronising the cadence of one or more slave readers with a master reader. This reduces interference and improves the reliability and accuracy of reading. In addition, because the synchronisation signal is digitally encoded, it has been found that the synchronisation signal can be received by a slave reader even where there is significant interference from other signals. This allows the synchronisation signal to be used for readers a greater distance apart.

### GNSS Synchronisation

Some readers have a cadence signal generator which is configured to maintain a cadence. For example, an oscillator, such as a voltage-controlled oscillator, can be used to maintain a period of the cadence. By setting the oscillator to have a predetermined cadence, the reader may have a regular transmit period and receive period. It can therefore be important to synchronise the cadence of the cadence signal generator, to avoid one reader's transmit mode interfering with another reader's receive mode.

As noted above, a slave reader may be synchronised with a master reader. However, it may be useful to include an alternatively approach, in cases where a synchronisation signal from the master reader is unavailable. For example, due to atmospheric conditions, the distance a signal can travel may be lower than expected, and so the master reader's synchronisation signal may no longer be received by the slave reader.

In addition, it may be useful to synchronise the master reader's cadence according to an external source. This can allow multiple master readers to be synchronised, and thus for reader systems to have a larger geographical spread.

One approach is to use a pulse generated by a GNSS receiver. A GNSS receiver is configured to receive readings from a Global Navigation Satellite System (GNSS), such as GPS, GLONASS, BeiDou, or Galileo. Each GNSS system has a number of satellites which transmit a signal at a regular period, controlled by highly accurate atomic clocks. Based on the receipt of the signals from multiple satellites, a user can determine their position. However, due to the precise timing of the signals, these can be used to generate a pulse at a regular interval. This is highly precise, as it is synchronised to the satellites.

A GNSS receiver can therefore produce a pulse in synchrony with any other GNSS receiver. By synchronising the cadence of the readers to the pulse generated by a GNSS receiver, the cadence of each readers is therefore synchronised with each other.

This may be used by a master reader in order to synchronise its cadence signal generator and/or to generator an analogue cadence signal. Since slave readers may be synchronised with the master reader ultimately using the analogue cadence signal, slave readers can be synchronised indirectly using a pulse from a GNSS receiver.

In other cases, this approach may be used in a slave reader as a backup or an alternative to the synchronisation signal from the master reader. This can enhance the accuracy or resilience of a reader system, since the master reader is no longer a single point of failure.

The approach may also be used by a reader that is not in a master-slave arrangement. Multiple readers can operate in synchrony without directly communicating by relying on a pulse from a GNSS receiver.

FIG. 4 shows an example approach for synchronising a reader based on GNSS.

At step 401, a pulse is received from a GNSS receiver.

The pulse is output from the GNSS receiver at a regular period, such as every second. This can be transmitted to the reader, for example through a connection from a pulse output of the GNSS receiver to an input of the reader. The pulse may have a predetermined duration, such as 100 ms.

At step 402, a cadence is synchronised based on the pulse.

In this context, a cadence comprises a transmit period and a receive period corresponding to when the reader should be in a transmit mode and a receive mode respectively.

Synchronising the cadence may involve setting a start of the cadence (or the start of the transmit period) based on the start of the pulse. This may further involve updating a cadence signal generator at the reader based on the cadence period of the decoded digital synchronisation signal. For example, this may be an oscillator, such as a voltage-controlled oscillator.

This may be performed by a cadence synchronisation module at the reader. The cadence synchronisation module may be a hardware circuit configured to perform the synchronising, for example by interacting with the cadence signal generator and the GNSS receiver. Alternatively, the cadence synchronisation module may be a series of instructions executable by a processor of the reader to perform the synchronisation.

In some cases, this cadence period is an integer multiple of the period of the pulse. This allows for the cadence period to be synchronised after an integer number of periods.

Where the cadence period is not an integer multiple of the period of the pulse, an offset may be applied to pulses to accommodate this. For example, an integer number of 60 ms cadence periods do not fit into a Is pulse period. Thus, a first cadence period may be synchronised with a first pulse, since they both occur at a nominal start time (such as midnight). The sixteenth cadence should occur 960 ms from the start time and the seventeenth period occurs 1020 ms from the start time. Neither of these align with the second pulse which should occur 1000 ms from the start time. Thus, synchronisation using the second pulse may be based on the sixteenth cadence plus an offset of 40 ms. Similarly, synchronisation using the third pulse may be based on the thirty-third cadence plus an offset of 20 ms. The fiftieth cadence and the fourth pulse then co-occur.

By using an offset in this manner, a pulse can be synchronised to any cadence period, even where the start of a cadence does not always co-occur with the start of a pulse.

At step 403, a transmit period and a receive period are calculated based on the cadence.

The transmit period corresponds to a period during which the reader is in a transmit mode, and the receive period corresponds to a period during which the reader is in a receive mode. The duration and relative timing of these may be set in advance according to a cadence period and a cadence ratio.

Because the cadence is set based on the pulse, the transmit period and receive period are consequently indirectly calculated based on the pulse.

This may occur at a cadence calculation module at the reader. The cadence calculation module may be a hardware circuit configured to perform the calculating. Alternatively, the cadence calculation module may be a series of instructions executable by a processor of the reader to perform the calculation.

At step 404, the reader operates according to the transmit period and the receive period.

In the transmit period, the reader is in a transmit mode. The reader transmits an excitation signal. This may be transmitted to an electronic animal identification tag attached to an animal, with a view to energising the tag.

In a receive period, the reader is in a receive mode. The reader monitors for signals from tags. In this mode, the reader may receive a signal from an energised tag attached to an animal.

In this way, multiple readers may be synchronised (that is, enter their transmit mode and receive mode) in synchrony by relying on a GNSS receiver. This reduces the chance of one reader's transmit mode interfering with another reader's receive mode, and may provide a more reliable reader system.

In some embodiments, a slave reader may selectively synchronise its cadence based on a synchronisation signal from a master reader or from a GNSS receiver. In some cases, the cadence is primarily synchronised based on the GNSS receiver. The synchronisation signal from a master reader may only be used if the GNSS receiver is unable to output a signal (for example, due to atmospheric conditions). In other cases, the synchronisation signal from the master reader is the primarily used for synchronisation. However, if the master reader synchronisation signal has not been synchronised with a GNSS receiver (or in other words, the master reader does not have GNSS lock), the slave reader may switch to synchronising with the GNSS receiver.

This improves the resilience of the slave readers. By providing redundant synchronisation methods, the slave reader can continue to function even parts of the system are malfunctioning.

### Error Correction

In the approaches noted above, a cadence at a reader may be synchronised from time to time. For example, using a GNSS receiver, the cadence at a reader may be synchronised every second.

However, the cadence period is often significantly shorter than this, for example 100 ms or 60 ms. This cadence is controlled by a cadence signal generator, such as a voltage-controlled oscillator at the reader.

It is common for cadence signal generators to drift over time. For example, each cadence period, the cadence period tends to grow or shrink, depending on the characteristics of the cadence signal generator. For example, in some cases, the cadence period may grow by 10 ms each 1s.

This drift may be different for each reader. Because of this drift accumulating over time, readers tend to fall out of synchrony. Eventually this can lead to the reader system being inoperable due to excess interference between readers.

Synchronising the signals of readers frequently can avoid excessive accumulated drift. However, if this synchronisation is unavailable (for example, if atmospheric conditions rendering cause GNSS signals unable to be used for synchronisation), this can prevent a reader system from operating.

One approach to mitigating this is to correction for the drift. This allows the local cadence signal (that is, the cadence signal from a cadence signal generator) to remain relatively close to a reference cadence signal (that is, the cadence of the synchronisation signal from the master reader, or the pulse from a GNSS receiver) for a longer time.

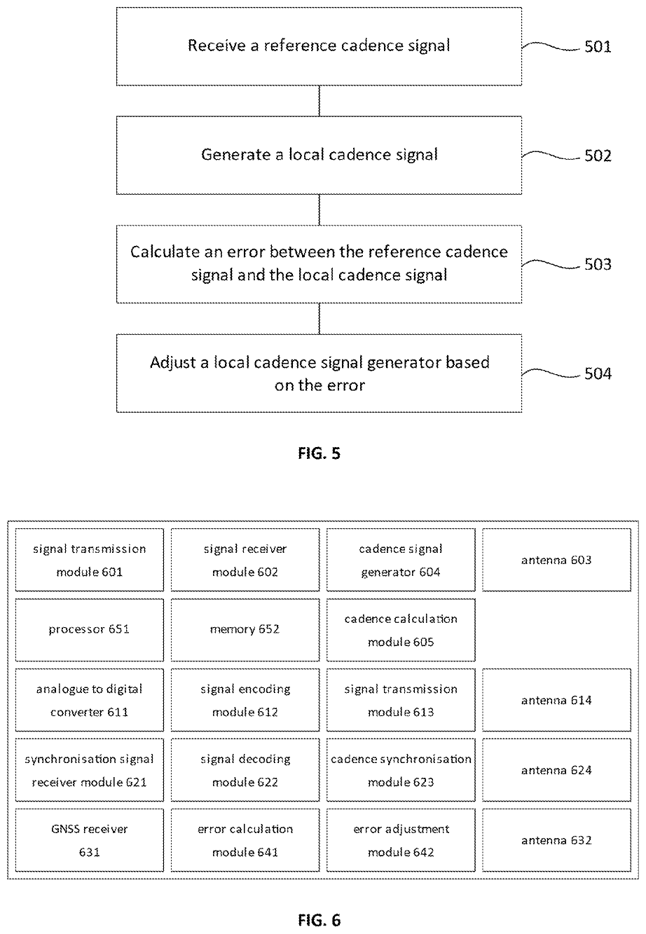

FIG. 5 shows an example method for how to improve the accuracy of a cadence signal generator.

At step 501, a reference cadence signal is received.

Where the method is performed by a master reader or a standalone reader (that is, one which does not operate in a master-slave arrangement), the reference cadence signal may correspond to the pulse generated by a GNSS receiver.

Where the method is performed by a slave reader, the reference cadence signal may correspond to the pulse generated by a GNSS receiver or to the synchronisation signal transmitted by the master reader.

This may occur during the ordinary operation of the reader. For example, the reference cadence signal may be received for synchronisation.

Where a synchronisation signal is received from a master reader, this may occur at a synchronisation signal receiver module of the reader. The synchronisation signal receiver module may be a hardware circuit configured to perform the receiving via an antenna. Alternatively, the synchronisation signal receiver module may be a series of instructions executable by a processor of the reader to receive the data over the antenna.

At step 502, a local cadence signal is generated.

This is generated by a cadence signal generator at the reader, such as a voltage-controlled oscillator. This may occur during the ordinary operation of the reader. For example, a local cadence signal may be generated to determine the transmit period and receive period of the reader.

Typically, this occurs before a synchronisation of the cadence signal generator occurs. This is because, immediately after synchronisation, the reference cadence signal and the local cadence signal should be substantially the same.

At step 503, an error between the reference cadence signal and the local cadence signal is calculated. This may occur by calculating an absolute time difference between the start of a period according to the local cadence signal and the start of a period according to the reference cadence signal.

The local cadence signal and reference cadence signal may be of different periods. For example, the local cadence signal may correspond to a 100 ms cadence while the reference cadence signal may correspond to a 1 s pulse. In this case, the error is calculated based on when the start of each signal should occur at the same time (for example, after 10 cadences).

This may occur at an error calculation module of the reader. The error calculation module may be a hardware circuit configured to perform the calculation. Alternatively, the error calculation module may be a series of instructions executable by a processor of the reader to perform the calculation.

At step 504, the local cadence signal generator is adjusted based on the error. This is to minimise the difference between the reference cadence signal and the local cadence signal (or in other words, to minimise the error that may be computed in a subsequent performance of step 503). Minimising in this case may mean reducing the error to below an acceptable error threshold. For a 100 ms cadence period, an acceptable error may be 250 μs, and so the adjustment aims to reduce the error below 250 μs.

In some cases, the local cadence signal generator is adjusted to generate a local cadence signal earlier or later based on the error. This may be a fraction of the error (such as 50% of the error), to allow for incremental change. For example, if the calculated error is 10 ms per cadence period (that is, the local cadence signal is 10 ms later than the reference cadence signal), the local cadence signal generator may be adjusted so that a subsequent local cadence signal is generated 5 ms earlier. This would be expected to reduce the next calculated error to 5 ms.

In some cases, the adjustment occurs only if the calculated error is above a threshold. This avoids minimal adjustments being made when the local cadence signal and reference cadence signal align for practical purposes. For example, the adjustment may only occur if the error is above 150 μs.

This may occur at an error adjustment module of the reader. The error adjustment module may be a hardware circuit configured to perform the adjustment. Alternatively, the error adjustment module may be a series of instructions executable by a processor of the reader to perform the adjustment.

In this way, over time the accumulation of the drift is minimised by the error-based adjustment of the cadence signal generator.

Where this approach is used as a master reader or at a standalone reader, the reader may rely on a reference cadence signal corresponding to the pulse of a GNSS receiver. This approach allows the local cadence signal from the cadence signal generator to more closely match the reference cadence signal for longer. Since this is propagated to slave readers, this can allow the system as a whole to work more resiliently.

Where this approach is used at slave readers, a slave reader may rely on a reference cadence signal corresponding to a synchronisation signal from a master reader and/or a reference cadence signal corresponding to the pulse of a GNSS receiver. This approach allows the local cadence signal from the cadence signal generator to more closely match the reference cadence signal for longer. This avoids a reader from transmitting during another reader's receive period for longer, and therefore can allow the system as a whole to work more resiliently.

### Reader

The approaches noted above may be implemented in a reader system comprising a number of readers.

An example such reader is shown in FIG. 6. A reader has a signal transmitter module 601 for transmitting a signal to an electronic animal identification tag and a signal receiver module 602 for receive a signal from an electronic animal identification tag. These may use an antenna 603 (or may each use a separate antenna). The reader has a cadence signal generator 604, such as a voltage-controlled oscillator, configured to generate a cadence signal, and a cadence calculation module 605 for calculating a transmit period and a receive period based on the cadence signal.

A reader may further have an analogue-to-digital converter 611 for converting an analogue cadence signal to a digital synchronisation signal, a signal encoding module 612 for generating an encoded synchronisation signal, and a synchronisation signal transmission module 613 for transmitting an encoded synchronisation signal to a slave reader. The synchronisation signal transmission module 613 may be in communication with an antenna 614 (though this may be the same as antenna 603). In some cases, the analogue-to-digital converter 611, the signal encoding module 612, the synchronisation signal transmission module 613, and the antenna 614 may be provided only on a reader intended to operate as a master reader.

A reader may further have a synchronisation signal receiver module 621 configure to receive an encoded digital synchronisation signal, a signal decoding module 622 configured to generate a decoded digital synchronisation signal, a cadence synchronisation module 623 configured to synchronise the cadence signal generator 604. The synchronisation signal receiver module 621 may be in communication with an antenna 624 (though this may be the same as antenna 603 or antenna 614)

A reader may further have a GNSS receiver 631 for receiving signals of a GNSS. The GNSS receiver 621 may be in communication with an antenna 632 (though this may be the same as antenna 603, antenna 614, or antenna 624).

A reader may further have an error calculation module 641 for calculating an error between a local cadence signal and a reference cadence signal, and an error adjustment module 642 for adjusting the cadence signal generator 604 based on an error.

One or more of the modules noted may be omitted in certain embodiments.

Although the modules have been shown as separate components, in some embodiments these are implemented in software. That is, computer-executable instructions corresponding to the functions performed by one of more of the modules are stored in a computer-readable medium, such as a memory 652 of the reader. One or more processors 651 of the memory can then execute the instructions, which perform the corresponding functions.

### Interpretation

Where a series of steps has been described, these steps need not necessarily be performed in the stated order (unless context requires otherwise). That is, steps may be performed out of order or in parallel in different embodiments.

The term “comprises” and other grammatical forms is intended to have an inclusive meaning unless otherwise noted. That is, they should be taken to mean an inclusion of the listed components, and possibly of other non-specified components or elements.

The present invention has been illustrated by the description of some embodiments. While these embodiments have been described in detail, this should not be taken to restrict or limit the scope of the claims to those details. Additional advantages and modifications will readily appear to those skilled in the art. Therefore, the invention in its broader aspects is not limited to the specific details of the illustrative examples shown and described. Accordingly, modifications may be made to the details without departing from the spirit or scope of the general inventive concept.

1. A system for synchronizing a plurality of electronic animal tag readers, the system comprising:
a plurality of electronic animal tags;
a plurality of electronic animal tag readers;
a wireless synchronization signal that includes a cadence signal;
wherein at least one of the plurality of electronic animal tag readers is a master reader;
wherein at least one of the remaining electronic animal tag readers is a slave reader;
wherein the slave reader includes a local cadence signal generator;
wherein
the master reader sends the wireless synchronization signal to the slave reader and;
the local cadence signal generator generates a local cadence signal;
the slave reader compares the cadence signal in the wireless synchronization signal to the local cadence signal and corrects the local cadence signal to match the cadence signal in the wireless synchronization signal.

2. The system of claim 1, wherein the wireless synchronization signal is further synchronized to an external signal.

3. The system of claim 2, wherein the external signal is a Global Navigation Satellite System (GNSS) signal.

4. The system of claim 1, wherein the master reader and slave reader use the cadence signal to calculate a transmit period and a receive period.

5. The system of claim 1, wherein each reader of the plurality of electronic animal tag readers is associated with a unique location.

6. The system of claim 5, wherein the unique location is chosen from a race, a barn, a pen, or an entrance or exit to a race, pen, or barn.

7. The system of claim 1, wherein the mater reader is selected from among the plurality of electronic animal tag readers based on its location.

8. The system of claim 1, wherein the plurality of electronic animal tag readers remain synchronized, in absence of the wireless synchronization signal, based at least in part on the local cadence signals.

9. The system of claim 1, wherein the master reader encodes the wireless synchronisation signal to generate an encoded wireless synchronisation signal before transmitting the encoded wireless synchronization signal;
and wherein the slave reader decodes the encoded wireless synchronization signal before comparing it to the local cadence signal.

10. The system of claim 9, wherein the encoded wireless synchronization signal is smaller than the wireless synchronization signal.

11. The system of claim 1, wherein the system comprises
a plurality of systems of slave readers, each system comprising at least one slave reader;
and wherein at least one of the plurality of systems of slave readers is synchronized to a different cadence signal than another system of slave readers.

12. A method for synchronizing a plurality of electronic animal tag readers, the method comprising:
a plurality of electronic animal tags;
a plurality of electronic animal tag readers including at least one master reader and at least one slave reader;
wherein the master reader sends a wireless synchronization signal that includes a cadence signal to the slave reader;
wherein the slave reader generates a local cadence signal;
and wherein the slave reader compares the cadence signal in the wireless synchronization signal to the local cadence signal and corrects the local cadence signal to match the cadence signal in the wireless synchronization signal.

13. The method of claim 12, wherein the wireless synchronization signal is further synchronized to an external signal.

14. The method of claim 13, wherein the external signal is a Global Navigation Satellite System (GNSS) signal.

15. The method of claim 12, wherein the plurality of electronic animal tag readers remain synchronized, in absence of the wireless synchronization signal, based on the local cadence signals.

16. The method of claim 12, wherein the master reader encodes the wireless synchronisation signal to generate an encoded wireless synchronisation signal before transmitting the encoded wireless synchronization signal;
and wherein the slave reader decodes the encoded wireless synchronization signal before comparing it to the local cadence signal.

17. The method of claim 16, wherein the encoded wireless synchronization signal is smaller than the wireless synchronization signal.

18. The method of claim 12, wherein the master reader communicates with a plurality of different systems of slave readers and wherein at least one of the plurality of systems of slave readers is synchronized to a different cadence signal than another system of slave readers.
